(19) United States
(12) Patent Application Publication
(10) Pub. No.: US 2013/0275157 A1
(43) Pub. Date: Oct. 17, 2013

(54) METHOD AND SYSTEM FOR BIOLOGICAL INFORMATION ASSESSMENT

(71) Applicants: Mark Doyle, Wexford, PA (US); Robert Biederman, Wexford, PA (US)

(72) Inventors: Mark Doyle, Wexford, PA (US); Robert Biederman, Wexford, PA (US)

(21) Appl. No.: 13/863,905

(22) Filed: Apr. 16, 2013

Related U.S. Application Data
(60) Provisional application No. 61/625,230, filed on Apr. 17, 2012.

(51) Int. Cl. G06F 19/00; G06Q 50/24

(52) U.S. Cl. CPC G06F 19/3487; G06Q 50/24
USPC 705/3

(57) ABSTRACT

A method and system for biological information assessment receives uses a set of grouped historic medical test results to generate testing protocol recommendations medical test results for a new patient. Each medical test result represents a measured observation of a portion of a historic patient's body using a first medical testing modality. A score is generated for each of the historic patients based on the results. Based upon the generated scores, the historic patients are grouped into a set of groups corresponding to a range of assessment parameters. When a medical test result is received for a new patient, the medical test result is compared to the range of assessment parameters to determine which of the groups the new patient should be assigned. The new patient is assigned to the determined group and a recommendation for an additional medical testing protocol is generated.

### CROSS REFERENCE TO RELATED APPLICATION

This application claims the priority benefit of U.S. Provisional Application No. 61/625,230 filed Apr. 17, 2012 and entitled “Method and System For Biological Information Assessment,” the content of which is hereby incorporated by reference in its entirety.

### BACKGROUND

Tests that gather biological information, such as medical tests, are routinely administered in many situations. Medical tests such as magnetic resonance imaging, electrocardiograms, and other tests are often given to patients to help diagnose a variety of medical conditions. In addition, in routine clinical practice, a patient may receive a series of medical tests.

Because of the cost, time, degree of invasiveness, and patient inconvenience involved with medical testing, it is desirable to limit the application of certain tests to patients for whom the test is likely to be relevant. In the past, the determination of whether or not a test is appropriate has relied on human judgment. Typically, lower-order tests (e.g., magnetic resonance imaging) have been applied to determine a patient's eligibility for higher-order tests (e.g., coronary artery catheterization). Reliable subjective systems are lacking.

This disclosure relates to an improved method for identifying populations that are subjected to a biological information assessment, such as a medical test.

### SUMMARY

In one general respect, a first embodiment discloses a method for biological information assessment. The method includes receiving a new medical test result for a new patient, comparing the new medical test result to a range of assessment parameters to determine to which of a plurality of patient groups the new patient should be assigned, assigning the new patient to the determined group, and, based on the determined group, generating a recommendation for an additional medical testing protocol for the new patient.

Further, the method may also include receiving a plurality of medical test results for a plurality of historic patients, each medical test result representing a measured observation of a portion of a patient's body using a first medical testing modality, generating a second score for each of the historic patients based on the historic patients' test results, and grouping the historic patients into the plurality of patient groups based upon the generated second scores, wherein each group corresponds to the range of assessment parameters.

In another general respect, a second embodiment discloses a system for biological information assessment. The system includes a processing device and a non-transitory computer readable medium operably connected to the processor, the computer readable medium containing a set of instructions. The instructions are configured to cause the processing device to receive a new medical test result for a new patient, compare the new medical test result to a range of assessment parameters to determine to which of a plurality of patient groups the new patient should be assigned, assign the new patient to the determined group, and, based on the determined group, generate a recommendation for an additional medical testing protocol for the new patient.

Further, the set of instructions may also include instructions to receive a plurality of medical test results for a plurality of historic patients, each medical test result representing a measured observation of a portion of a patient's body using a first medical testing modality, generate a second score for each of the historic patients based on the historic patients' test results, and group the historic patients into the plurality of patient groups based upon the generated second scores, wherein each group corresponds to the range of assessment parameters.

### BRIEF DESCRIPTION OF THE DRAWINGS

FIG. 1 is a diagram showing how diagnostic tests may be evaluated relative to a baseline which represents a test that provides essentially no information about the patient.

FIG. 2 is a flowchart illustrating a first method for initializing a biological information assessment scoring method.

FIG. 3 illustrates a possible relationship between quartiles of a set of patients, as grouped by biological information assessment score, and agreement between a lower-order test and a higher-order test.

FIG. 4 illustrates a relationship between the quartiles of FIG. 3 and the presence of disease as assessed using the higher-order test.

FIG. 5 is diagram showing a relationship of a baseline, a biological information assessment score determined by the embodiments of this document, and a prior art test performance.

FIG. 6 illustrates how a threshold for determining disease presence applied to a diagnostic test may vary based on a biological information assessment score.

FIG. 7 is a flowchart illustrating a second method of initializing a biological information assessment scoring method.

FIG. 8 is a flowchart showing an example of how the methods of this document may be used in a clinical setting.

FIG. 9 illustrates various elements of a computing device for implementing various methods and processes described herein.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.” As used in this document, the terms “sum,” “product” and similar mathematical terms are construed broadly to include any method or algorithm in which a single datum is derived or calculated from a plurality of input data.

As used herein, the term “modality” refers to a mode, process or method of obtaining a set of data. For example, a modality may include a specific medical test or an imaging process that may be used to obtain and/or assess biological information about a medical patient.

The term “processing device” refers to one or more computing devices configured to operate as defined by one or more instructions to perform at least a specific process. Multiple computing devices may be organized into a group of devices, and a processing device, as used herein, may include any combination of computing devices contained within the group.

This disclosure discusses cardiac medical imaging and other cardiac testing as examples of medical testing modalities for the purposes of illustration. However, this example is provided for illustration only. The embodiments discussed in this document may be used for any medical testing modality or combinations of medical testing modalities.

Cardiac medical images such as those obtained by single photon emission computed tomography (SPECT) imaging and cardiovascular magnetic resonance imaging (MRI) have various uses. Examples include a diagnostic use and a prognostic use. The diagnostic use of SPECT images may be to identify a partially blocked coronary artery. This information may be used to determine a course of treatment based upon the clinician's interpretation of the evidence (e.g., presence of a myocardial perfusion deficit) discovered in the images. In prognostic use, the presence of a perfusion deficit detected by the modality may indicate that the patient is at an increased risk of an adverse event (e.g., suffering a myocardial infarction). Thus, a patient with a SPECT image-identified perfusion deficit may receive intensified treatment due to an established diagnostic and prognostic value associated with interpretation of the SPECT images. Those patients not judged to have a deficit are typically sent home without further treatment. These decisions are made by humans based upon their experience with patients or by studying the results of various clinical trials.

In the past, determining whether a patient has a positive or a negative result from a medical test such as SPECT, MRI or another medical test has largely relied on a combination of objective and the subjective interpretation by the physician. For instance, an interpretation of an MRI or SPECT image may involve the identification of a low signal region (e.g. apparent in an image frame), or a low rate of signal uptake over time (e.g. apparent over a time-ordered series of image frames). The threshold to adjudicate what constitutes a low uptake rate or low signal would be obtained by using historical data sets, where examples of images and known levels of disease or outcome are provided to the physician for training purposes. However, since there is great heterogeneity between patients, some patients without disease may be interpreted as positive (false positive) or and some patients with disease may be diagnosed as negative (false negative) and these errors detracted from the accuracy of the test. Further, these errors deterred the use of computerized algorithms since there was no single threshold of low signal or low uptake rate that consistently corresponded to accurate disease detection. Thus, in addition to observation of relative signal and uptake rates, the decision of whether a patient's data indicated disease or not often required subjective considerations to be made by the physician concerning factors such as symptoms and physiologic positioning of the potential perfusion defect. Despite this, false positive and false negative readings continue to reduce accuracy since ambiguity in the training data has translated to interpretation of current data, and thus the limited accuracy of the diagnostic test tends to stabilize over time. Further, as technological advances are made in performance of the diagnostic test, they typically promise to result in only incremental improvements in accuracy.

However, in many cases technological advances only add to the confusion, since it is unknown what combination of quantitative and subjective interpretation criteria are required in data interpretation, leading to persistence of false positive and false negative rates. One way to express this situation is to acknowledge that the ideal diagnostic test does not exist and thus any one way of interpreting images will necessarily not be accurate for all patients in a population, that is, even when access to quantifiable characteristics of the image signal are available to a computer algorithm, no single threshold of signal level or signal uptake rate will satisfactorily identify patients having disease as compared to disease-free patients. Absence of the ideal test ultimately leads to misdiagnosis, either by the physician interpretation or by an algorithmic approach implemented in a computer.

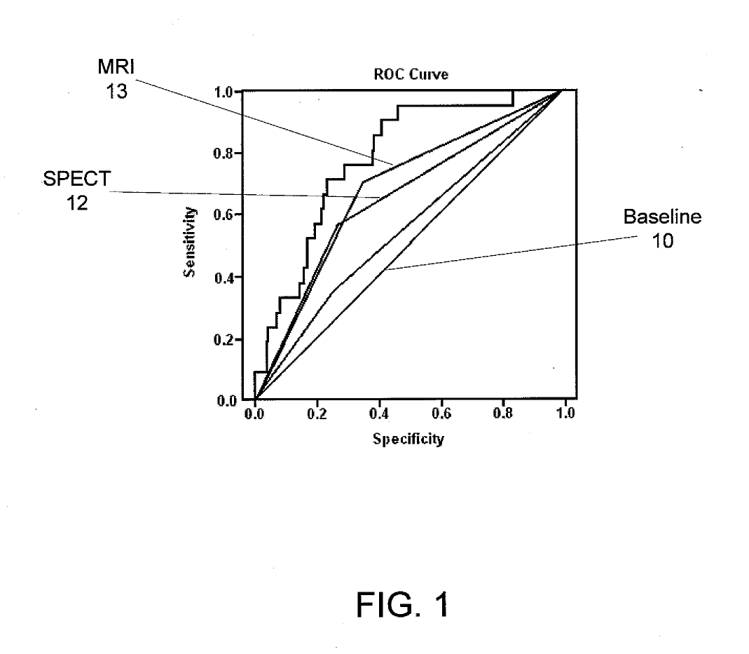

One graphical approach to evaluate the performance of a diagnostic test is to look at its performance using a Receiver-Operator Characteristic (ROC) plot, an example of which is shown in FIG. 1. Each ROC curve illustrates the sensitivity (i.e., true positive rate) vs. 1-specificity (i.e., false positive rate) of a testing modality. It is desirable for a testing modality to have a high area under the curve, as a test with a greater area under the curve than another test better captures true positives and true negatives. In FIG. 1, the diagonal plot 10 represents the performance of a test based purely or primarily on random chance, with little or no actual patient data incorporated. The diagonal line may be regarded as a baseline from which the performance of the test is evaluated. One way to regard the baseline is that it represents the state of knowledge concerning the patient's disease status prior to interpreting the test. The plot also shows example of actual testing performance using various testing modalities, such as SPECT 12 and MRI 13, among others.

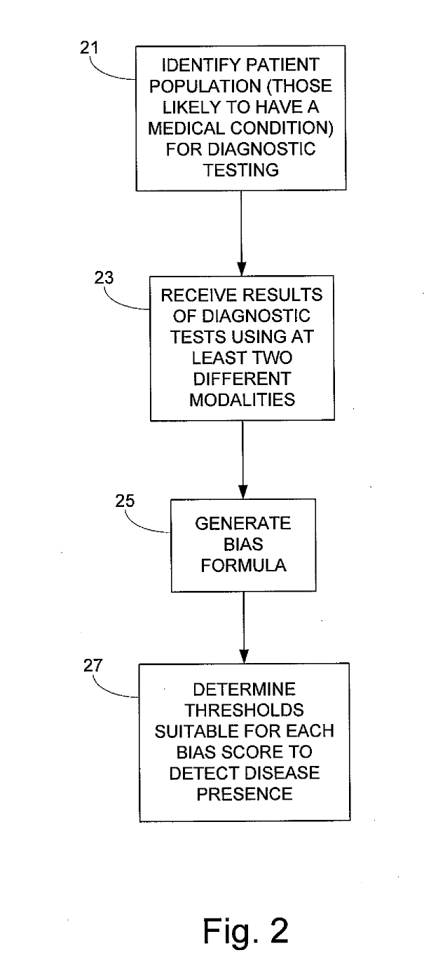

The presently-disclosed embodiment of performing a biologic information assessment uses an initialization phase and an implementation phase. The initialization phase determines 1) a formula that may be used to score test results from a patient population and 2) a means of setting a variable threshold of signal intensity or signal uptake rate to separate patients into significant disease present or absent, with the threshold level being dependant on the score test value. An example of signal level is the signal intensity noted in SPECT images corresponding to the heart tissue, and an example if signal uptake rate is the signal level noted across time sequential MRI perfusion images of the heart tissue. The initialization phase may be illustrated in at least two ways. A first way to initialize a biological information assessment is illustrated in FIG. 2. Referring to FIG. 2, a patient population is selected 21. The patient population is made up of individuals who are candidates for diagnostic testing based on likelihood of having a particular medical condition.

Each of the patients will be subjected to at least two diagnostic tests, and the data from each test is received 23 by a computing device and stored in a computer-readable memory in a suitable format, such as a database. The data for the patient sets are compared to generate one or more formulas that allow one modality to approximate the results of a second modality. One such procedures such as those disclosed in U.S. patent application Ser. No. 13/289,335, filed Nov. 4, 2011, the disclosure of which is incorporated herein by reference in its entirety. In this initialization stage, it is not necessary to have access to actual outcome data (e.g., knowledge of whether the patient lived or died). Rather, the formula may use parameters obtained from a medical professional's interpretation of the diagnostic test (e.g., a binary result that denotes 1 for positive, and 0 for negative). An example of such a formula is shown in Equation 1:

Model Prediction of MRI=−0.01+(0.3)*SPECT result+(0.05×EDV), Equation 1:

Wherein:
EDV=the end diastolic volume of the left ventricle as measured based upon a physician's or computer algorithm-directed reading of the SPECT image or images, and
SPECT result=the indication of whether the patient is positive (1) or negative (0) for disease based on the medical professional's interpretation of the SPECT modality.

A threshold is then selected for each formula based on the diagnostic data results of patients assessed at baseline. Thereafter, when data is received for a new patient, that data is entered into the computing device, which applies the data to the formula to yield a numerical value. If the numerical value equals or exceeds the threshold, the system will identify the patient as likely positive for the medical condition. If the value is below the threshold, the system will identify the patient as likely negative for the medical condition.

In the embodiments described in this document, a biological information assessment formula is determined 25 using methods such as those described above, but without incorporating the medical professional's interpretation of the test. For example, an equation to predict the results of an MRI evaluation of perfusion status based upon data obtained from a SPECT examination may be as follows:

BIAS score=−0.01+(0.05×EDV), Equation 2:
wherein EDV=the end diastolic volume of the left ventricle as measured based upon a physician's or computer algorithm-directed reading of the SPECT image or images.

An equation such as Equation 2, which uses an objective medical testing measurement but does not consider the medical professional's subjective primary reading (i.e., positive or negative) of the test is referred to in this document as a “BIAS formula,” and the result of the equation for a given patient's test data is referred to as a “BIAS score.” For the second stage in initialization one or more thresholds suitable for each BIAS score may be set to detect the presence of a medical condition.

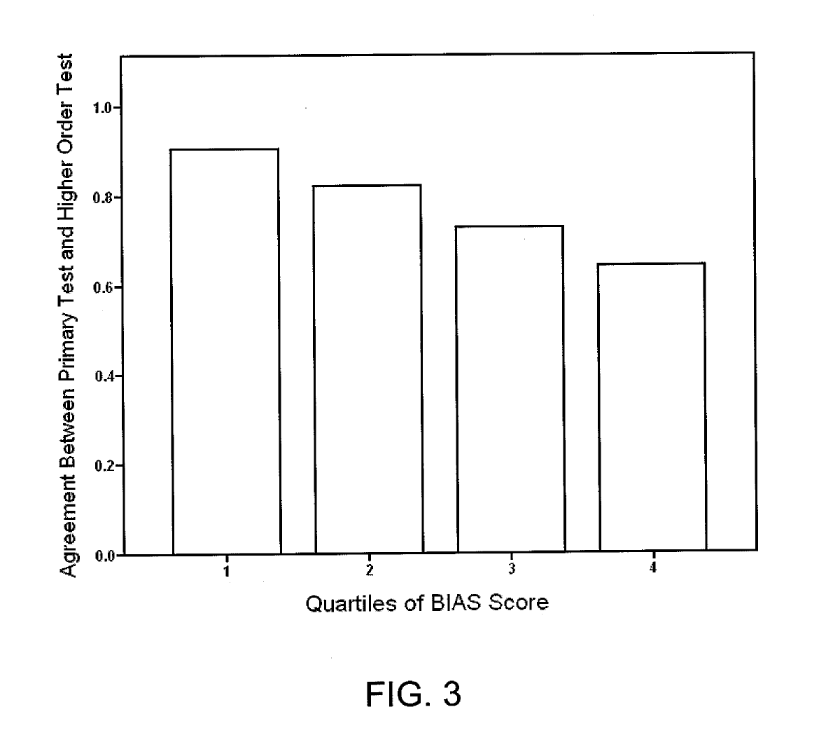

To understand how this is accomplished, firstly the properties of the BIAS score are illustrated. FIG. 3 illustrates an example where BIAS scores for a series of patients have been grouped into quartiles. The grouping into quartiles is entirely for illustration purposes, and in the limit, no grouping is required, since the BIAS score could be used directly. To group patients into quartiles, the BIAS score range for the patient group is divided into quartiles, such that the population of each is not necessarily equal, but the BIAS score of patients within each quartile have a range common to each quartile. Any BIAS score threshold may be set to separate one quartile from the next. In this example, BIAS scores are grouped from low (quartile 1) to high (quartile 4). FIG. 3 also indicates a level of agreement between the diagnostic test used to determine the BIAS score and a higher-order test. Note that the level of agreement progressively decreases as the BIAS quartile increases. The units along the ordinate axis correspond to the fraction of agreement between the lower-order diagnostic test and the higher-order test. It can be appreciated that the lower-order test becomes increasingly inaccurate as the BIAS score increases.

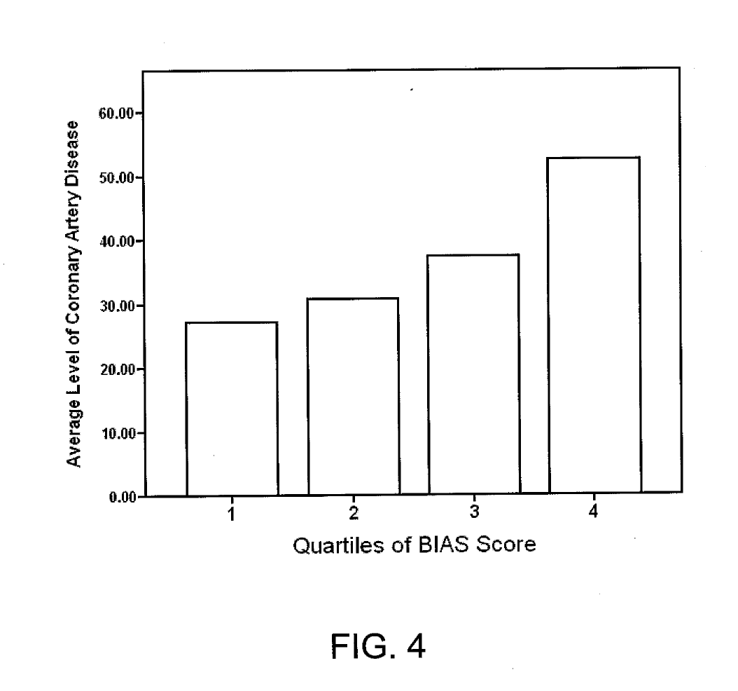

FIG. 4 illustrates the same grouping of patients into quartiles, but this time the ordinate axis plots the average level of the medical condition (expressed in percentage stenosis in the coronary arteries) measured in the higher-order test data (In this actual example, the medical condition being evaluated is the degree of coronary artery disease present.) Note that the average level of the disease severity (as assessed by a higher order test) progressively increases as the BIAS score increases.

Thus, based on interpretation of FIGS. 3 and 4, patients in quartile one (Q1) may represent the “ideal patient” for the lower-order diagnostic test. In this way, while it is acknowledged that no ideal test exists, Q1 patients represent the patient group in which the lower-order test performs close to ideally. Designating this group the “classical” patients, a threshold for low signal level or low uptake rate may be set using criteria that corresponds with the standard, historical, interpretation of the test. The consequence sought would be that patients in this classical group could have a uniform threshold applied to signal interpretation, and that the results would be highly accurate. The interpretation of this is that the test data are only minimally biased by conditions, and no subjective adjustment is required in interpretation of the image data. However, in contrast, for patients in quartile 4 (Q4), the low-order test is far from ideal and tends to under detect true disease and over detect disease where none exists. In this quartile there is a high level of disease but a low level of agreement between the lower and higher order testing modalities. Thus, the system may recommend that further interpretation of a low-order test should be abandoned so that the patient proceeds directly to a high-order test since the suspicion of disease is so high. (As an example, the system may recommend that the medical professional allow the low-order diagnostic test to terminate early, e.g. prior to a stress test being performed since these patients typically should be directly referred to the next higher-order test, such as coronary artery catheterization.).

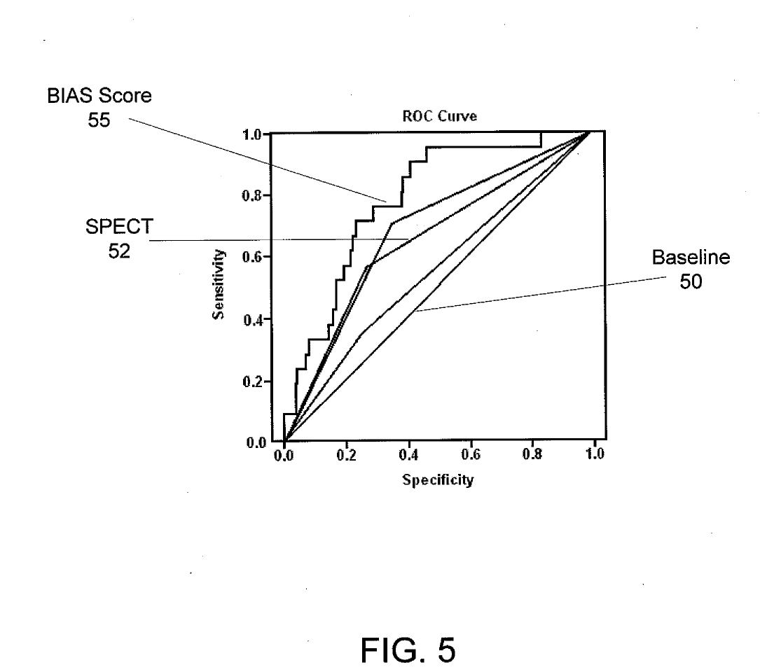

Before addressing how data in quartiles 2 and 3 may be interpreted, it is instructive to consider the BIAS score in terms of the ROC curve. One way to interpret a BIAS score is to view it in an ROC plot, as shown in the example of FIG. 5. In the ROC plot, it can be seen that the BIAS score 55 forms an arc, with an area under the curve (AUC) greater than a conventional physician-base interpretation of the diagnostic test such as that provided by SPECT 52 (using actual data). Consider that the BIAS score incorporates terms that can be obtained from the diagnostic test with the exception of the primary diagnosis. One way to interpret this is to regard the BIAS score as representing the situation prior to interpreting the patient data, that is, the baseline from which the diagnostic value of the test is measured is now taken as the BIAS curve as opposed to the diagonal line 50, which was previously considered to be a baseline. Thus, to add value beyond that provided by the baseline conditions, the test is interpreted in a manner that takes the characteristics of the BIAS score into consideration.

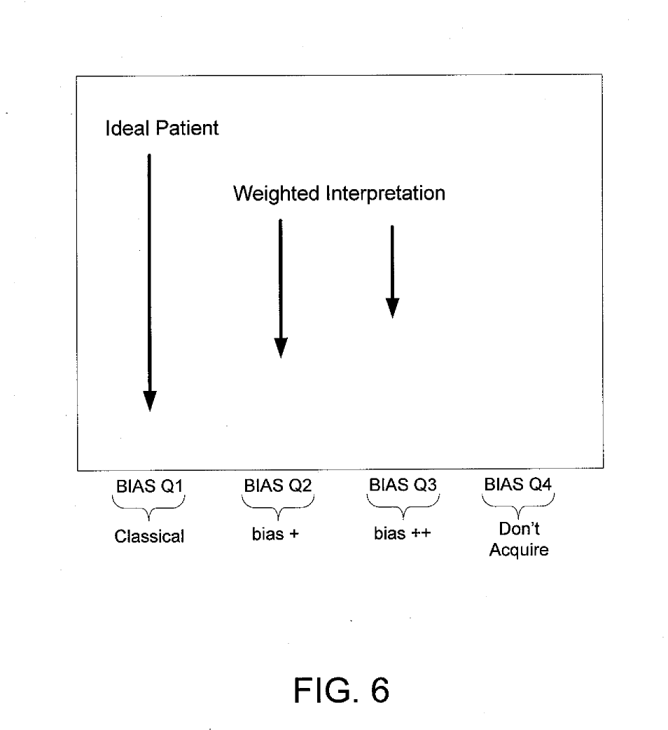

The manner in which data may be interpreted for patients in quartiles 1 and 4 were addressed above. Interpretation of data for patients in quartiles 2 and 3 involve adjustments to the threshold for assessing signal level or uptake rate. Considering the example of the data of FIG. 4, it can be seen that for this data set, the average level of coronary artery disease increased with increasing BIAS score, i.e. in quartiles 2 and 3, disease is likely more prevalent than in quartile 1. However, with reference to FIG. 3, manifestation of disease in the test data is likely to be obscured as the BIAS score increases. There is a recognition that the test data for patients in Q2 and Q3 cannot be interpreted in the “classical” manner of Q1. In Q2 and Q3 patients the threshold that was set for patients in Q1 is progressively lowered with increasing BIAS score, as indicated in FIG. 6.

The means of interpreting data, using a computer algorithm, can be performed by progressively lowering the threshold for determining whether disease is present as the BIAS score increases. The physical interpretation of this is that if a patient is in quartile 3, and only moderate signs of disease are present (e.g. a moderately low region of signal, or a relatively slow uptake rate of signal) this is sufficient to assign disease as being present. However, if the patient were in quartile 1, more dramatic levels of low signal or uptake rate would be needed to declare the patient to be positive for disease. Thus, the threshold for declaring a patient to be positive for disease is adjusted based on the BIAS score. Determining exactly how the threshold is adjusted based on BIAS score can be performed with or without knowledge of follow-up data. If no follow-up data are available, the variable threshold could be approximated by establishing by consensus, the threshold level in Q1 patients, and setting the threshold for Q4 patients to zero (since the test is unreliable in this group) and adjusting the threshold in a linear manner (for instance) between the Q1 level and the Q4 level (of zero). Alternatively, if follow-up data were available, the process of finding an optimal threshold for each quartile could be performed in a more systematic manner by setting the threshold of a signal level or uptake rate to best match the reading with the known outcome or higher-order disease findings. Thus, while it is acknowledged that no ideal test exists, BIAS identifies the patients where the test is regarded as close to ideal (quartile 1) and progressively shows how the test data should be interpreted as the BIAS score increases, until finally, the BIAS score is so high that the likelihood of disease is high and the means of correctly interpreting the data are low, indicating that no further testing can be usefully performed by that modality, and a higher-order test is indicated for this group.

In the embodiment of performing biologic information assessment given above, it should be noted that no follow-up data was required to formulate the BIAS score. (However, follow-up could aid in the determination of a progressive threshold for disease detection). Further, to illustrate the features of the BIAS score, the presence of disease by a higher-order test was provided, but this was not necessary to formulate the BIAS formula. Similarly, outcome data was used to show the characteristics of the BIAS score but was not used in the formulation of the BIAS score. However, the formulation required that data from two similar diagnostic modalities is available in one patient population. This data set has an important advantage that follow-up data is not required, and thus the approach can be applied and the BIAS formals generated in a relatively short time interval, i.e. without waiting for follow-up events to occur. However, a disadvantage of this type of data is that it is not commonly available from historical sources.

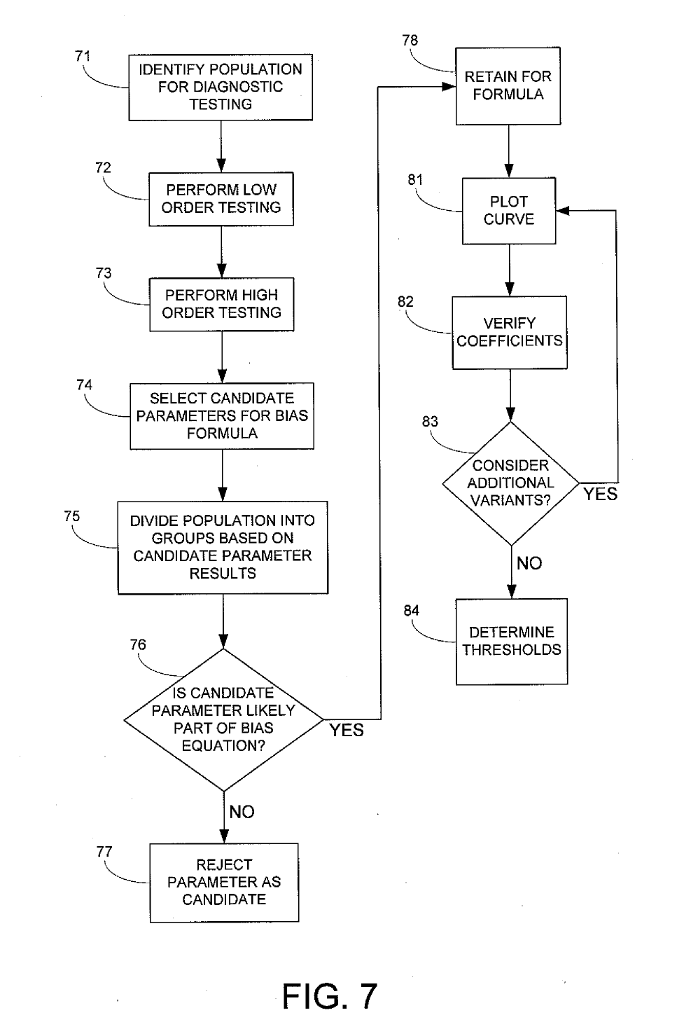

A second mode of initialization disclosed for the embodiment of performing a biologic information assessment requires either that additional testing be performed (using a higher-order test) or the availability of follow-up data, and is illustrated in FIG. 7. An advantage of this implementation is that this data set may be more widely available than the data set required for the embodiment described above. As shown above, the prevalence of disease increased with increasing quartiles of BIAS while the ability to correctly interpret data decreased with increasing quartile. This knowledge concerning the interaction of the BIAS score and correlation of outcomes and disease detection (with regard to true and false positive rates) can be used to identify candidate variables that would likely be components of a BIAS formula.

Referring to FIG. 7, the method may include identifying a population for diagnostic testing 71. This may include patients who are likely true and/or false positive patients, and the method may then determine biological parameters based on low order testing 72 and/or high order testing 73. One or more parameters will be selected as likely constituents of a BIAS formula 74. The patients will then be divided into groups 75 based on this parameter. For example, based on equation 2, the end diastolic volume, might be a candidate parameter investigated, and in this case successfully found to be a good variable. Similarly, the parameter of end systolic volume might be investigated and found to only moderately correlate, and thus would be rejected in favor of the end diastolic volume, or other parameters. The system may use the parameters for the patient set to generate a plot 76 of features such as the rate of agreement of test results and outcome, or the progression of disease prevalence with increasing or decreasing quartile. For each variable considered, if a pattern is seen that resembles the pattern noted above for the BIAS score, then that parameter may be considered a likely constituent of the BIAS formula 77. By conducting a series of such examinations, several likely components of the BIAS score can be identified 78, while parameters that do not exhibit the desired plot may be rejected 79.

A software program can perform a systematic investigation of the candidate parameters, and assign various candidate coefficients to each parameter to allow them to be combined into a candidate BIAS formula. The coefficients can be varied 82 to optimize the candidate BIAS formulae by various criteria available for each particular data set (e.g. optimizing the AUC of the BIAS score with respect to a known disease severity or event occurrence). This process can be repeated if desired 83.

Any given BIAS formula is unlikely to exactly replicate a BIAS formula generated using the first method, but the means of interpreting data will follow a similar approach. The stage of initialization involving the determination of thresholds 84 for disease identification for each BIAS quartile (or other grouping) can be conducted using knowledge of the outcome data. Examples of methods of determining suitable thresholds are described above in the discussion of FIG. 6. The advantage of generating the BIAS formula using the second method is that this data is typically acquired in historical trials, and likely allows BIAS formulas to be generated for several tests and patient characteristics using data that is readily available.

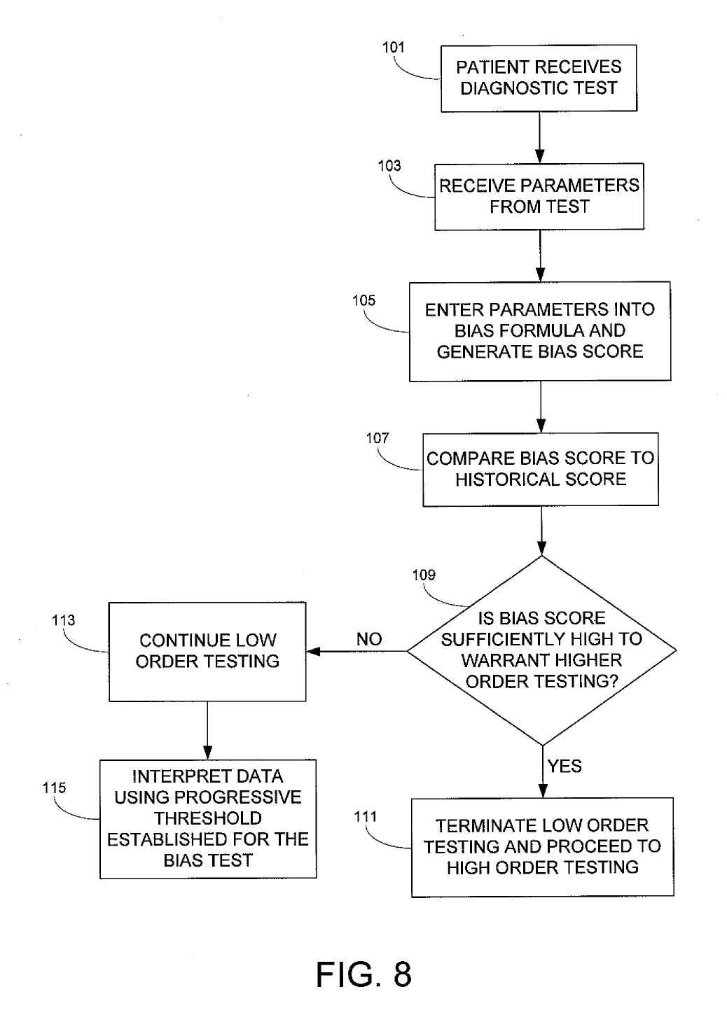

Referring to FIG. 8, during the implementation phase of BIAS, a patient will undergo a medical test 101 for which BIAS formula exists. The test will yield some parameters (i.e., data) that can be received by a computer system 103, which will then use the parameters to calculate a BIAS score for the patient. The patient's data will be compared to the historic BIAS data to determine which group the patient fits into. For example, the system may use a goodness of fit test or other statistical comparison to determine which group's data provides the best fit with the patient's data. For example, in a myocardial perfusion assessment using SPECT, a relative signal drop of 25% might indicate disease of a patient in quartile 1, but for a patient in quartile 3, the signal drop required might be 10%. Based on this data, the system will determine whether the patient's BIAS score is sufficiently high to proceed directly to higher order testing 109. For example, if the patient is characterized as residing in Q4 out of four quartiles (Q1, Q2, Q3, or Q4), the value of the test is likely very low. Thus, the system may generate a recommendation 111 to terminate low-order testing so that the patient can be sent on the next higher-order test. If the patient is in Q1-Q3, the system may generate a recommendation to continue low-order testing 113 to completion and obtain the data from the test. The system also may interpret that data 115 using the threshold suitable for the BIAS level of that patient.

Thus, the methods described above may improve the interpretation of a test with regard to the presence or absence of disease. In addition, the methods may help medical professionals determine whether a patient should proceed to a higher-order test, optionally without completing the lower-order diagnostic test.

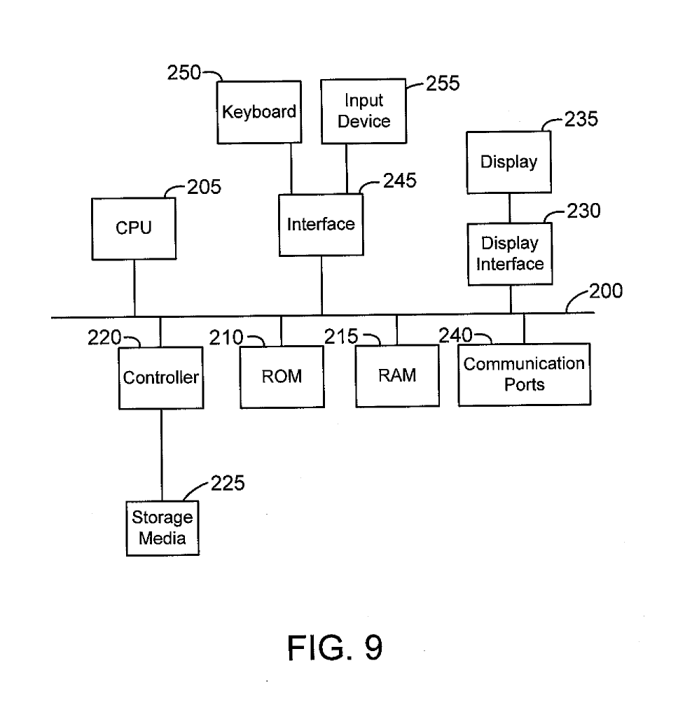

FIG. 9 depicts a block diagram of internal hardware that may be used to contain or implement various components to perform the processes illustrated the previous figures. A bus 200 serves as the main information highway interconnecting the other illustrated components of the hardware. CPU 205 is the central processing unit of the system, performing calculations and logic operations required to execute a program. CPU 205, alone or in conjunction with one or more of the other elements disclosed in FIG. 9, is an illustration of a processing device, computing device or processor as such terms are used within this disclosure. Read only memory (ROM) 210 and random access memory (RAM) 215 constitute examples of memory devices.

A controller 220 interfaces with one or more optional non-transitory memory devices 225 to the system bus 200. These memory devices 225 may include, for example, an external or internal DVD drive, a CD ROM drive, a hard drive, flash memory, a USB drive or the like. As indicated previously, these various drives and controllers are optional devices. Additionally, the memory devices 225 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing the BIAS process as discussed above may be stored in the ROM 210 and/or the RAM 215. Optionally, the program instructions may be stored on a non-transitory, tangible computer readable medium such as a compact disk, a digital disk, flash memory, a memory card, a USB drive, an optical disc storage medium, and/or other recording medium.

An optional display interface 240 may permit information from the bus 200 to be displayed on the display 245 in audio, visual, graphic or alphanumeric format. The information may include information related various data sets. Communication with external devices may occur using various communication ports 250. A communication port 250 may be attached to a communications network, such as the Internet or an intranet.

The hardware may also include an interface 265 which allows for receipt of data from input devices such as a keyboard 260 or other input device 265 such as a mouse, a joystick, a touch screen, a remote control, a pointing device, a video input device and/or an audio input device.

Several of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method, comprising:
receiving, by a processing device, a new medical test result for a new patient;
comparing, by the processing device, the new medical test result to a range of assessment parameters to determine to which of a plurality of patient groups the new patient should be assigned;
assigning, by the processing device, the new patient to the determined group; and
based on the determined group, generating, by the processing device, a recommendation for an additional medical testing protocol for the new patient.

2. The method of claim 1, wherein comparing the new medical test result to the range of assessment parameters comprises:
extracting, by the processing device, one or more new parameters from the new medical test result;
calculating, by the processing device, a first score for the new patient based upon the one or more new parameters; and
comparing, by the processing device, the first score to the range of assessment parameters to determine to which of the plurality of patient groups the new patient should be assigned.

3. The method of claim 1, wherein generating the recommendation for an additional medical testing protocol comprises:
comparing, by the processing device, the first score for the new patient to a testing threshold; and
determining, by the processing device, at least one additional test based upon a result of the comparison of the first score and the testing threshold.

4. The method of claim 3, further comprising:
receiving, by the processing device, a second medical testing result for the new patient;
comparing, by the processing device, the second medical testing result and a progressive threshold; and
determining, by the processing device, whether to continue testing the new patient based upon a result of the comparison of the second medical testing result and the progressive threshold.

5. The method of claim 4, wherein the progressive threshold is based upon the at least one additional test determined for the new patient.

6. The method of claim 1, further comprising:
receiving, by the processing device, a plurality of medical test results for a plurality of historic patients, each medical test result representing a measured observation of a portion of a patient's body using a first medical testing modality;
generating, by the processing device, a second score for each of the historic patients based on the historic patients' test results; and
grouping, by the processing device, the historic patients into the plurality of patient groups based upon the generated second scores, wherein each group corresponds to the range of assessment parameters.

7. The method of claim 6, wherein receiving a plurality of medical test results comprises:
identifying, by the processing device, a population of patients;
receiving, by the processing device, low order test results for the population of patients;
receiving, by the processing device, high order test results for the population of patients; and
determining, by the processing device, the range of assessment parameters for dividing the population into one or more groups.

8. The method of claim 7, wherein determining the range of assessment parameters further comprises rejecting one or more assessment parameters that do not fit within a testing equation.

9. The method of claim 6, further comprising determining one or more testing thresholds based upon the one or more candidate parameters and historically known outcome data for the population, wherein the outcome data comprises data acquired in historical trials for the population.

10. A system comprising:
a processing device; and
a non-transitory computer readable medium operably connected to the processor, the computer readable medium containing a set of instructions configured to cause the processing device to:
receive a new medical test result for a new patient,
compare the new medical test result to a range of assessment parameters to determine to which of a plurality of patient groups the new patient should be assigned,
assign the new patient to the determined group, and
based on the determined group, generate a recommendation for an additional medical testing protocol for the new patient.

11. The system of claim 10, wherein the instructions for causing the processing device to compare the new medical test result to the range of assessment parameters further comprise instructions for causing the processing device to:
extract one or more new parameters from the new medical test result;
calculate a first score for the new patient based upon the one or more new parameters; and
compare the first score to the range of assessment parameters to determine to which of the plurality of patient groups the new patient should be assigned.

12. The system of claim 10, wherein the instructions for causing the processing device to generate the recommendation for an additional medical testing protocol further comprise instructions for causing the processing device to:
compare the first score for the new patient to a testing threshold; and
determine at least one additional test based upon a result of the comparison of the first score and the testing threshold.

13. The system of claim 12, further comprising instructions for causing the processing device to:
receive a second medical testing result for the new patient;
compare the second medical testing result and a progressive threshold; and
determine whether to continue testing the new patient based upon a result of the comparison of the second medical testing result and the progressive threshold.

14. The system of claim 13, wherein the progressive threshold is based upon the at least one additional test determined for the new patient.

15. The method of claim 10, further comprising instructions for causing the processing device to:
receive a plurality of medical test results for a plurality of historic patients, each medical test result representing a measured observation of a portion of a patient's body using a first medical testing modality;
generate a second score for each of the historic patients based on the historic patients' test results; and
group the historic patients into the plurality of patient groups based upon the generated second scores, wherein each group corresponds to the range of assessment parameters.

16. The system of claim 15, wherein the instructions for causing the processing device to receive a plurality of medical test results further comprise instructions for causing the processing device to:
identify a population of patients;
receive low order test results for the population of patients;
receive high order test results for the population of patients; and
determine the range of assessment parameters for dividing the population into one or more groups.

17. The system of claim 16, wherein the instructions for causing the processing device to determine the range of assessment parameters further comprise instructions for causing the processing device to reject one or more assessment parameters that do not fit within a testing equation.

18. The system of claim 17, further comprise instructions for causing the processing device to determine one or more testing thresholds based upon the one or more candidate parameters and historically known outcome data for the population, wherein the outcome data comprises data acquired in historical trials for the population.
